(19) United States
(12) Patent Application Publication
(10) Pub. No.: US 2003/0234258 A1
(43) Pub. Date: Dec. 25, 2003

(54) Medicine compliance system

(76) Inventors: Dean Stephens, Culver City, CA (US); Mikki Segraves, Redondo Beach, CA (US); Elizabeth Shay, Redondo Beach, CA (US)

Correspondence Address: Niro, Scavone, Haller & Niro, 181 W. Madison-Suite 4600, Chicago, IL, 60602, US

(21) Appl. No.: 10/179,802

(22) Filed: Jun. 25, 2002

(51) Int. Cl. B65H 3/00; G07F 11/00; B65G 59/00

(52) U.S. Cl. 221/115

(57) ABSTRACT

A medicine compliance system is used for validating compliance with an entire drug regimen of dosages of different medicines in which the dosages are packaged in a dispensing container and identified in both a per medicine format and a dosage format.

### FIELD OF THE INVENTION

This invention relates to the field of medicine compliance, and more particularly to a medicine compliance system which provides a pharmacist and a patient with a graphical and written description of medication which must be taken on a predetermined schedule in combination with a dispensing container (consisting of a tray, trays, package, packages and/or vials) that simplifies the relationship between a particular day and time dosage and the representation of the medicines contained in each compartment or packets of the container for ease in validating the medicines required to be taken.

### BACKGROUND OF THE INVENTION

In many modem medical situations it is common for a patient to be prescribed a large number of different medications by his doctor or doctors to treat a disease and other related or unrelated medical conditions. These medications typically must be taken on a specific day and time schedule for optimal effect. Each medication is usually in the form of pills, capsules, liquids or syringes which must be used by the patient. When the disease or condition is being treated on an outpatient basis, it is the responsibility of the patient to take all of the medications at the appropriate times on the appropriate day. Compliance with these complex schedules is difficult when the information about the regimen is organized by medicine rather than by dosage time and day.

It is frequently the case that all of the medications are not taken according to the same schedule and multiple schedules exist for different times on different days. For example, some medications must be taken once a day. Other medications have a regimen where they are taken two or more times per day. Still other medications are taken less frequently, for example every other day or once per week. Keeping track of each medication, and the times on which it must be taken is extremely important. If a particular medication is missed, severe health consequences or even death can occur. The patient must therefore have an effective means of keeping track of the times and days when each medication must be taken. The simplest and best form of validation information will utilize the minimum number of information arrays or diagrams for the information chart to represent the minimum number of different schedules within a given time frame.

It is usually the case and known in the prior art that all information about medicines is identified solely by the medicine and its name or number, and information about the medicine is supplied as if it would be distributed independent of other medicines, since this is the legally mandated information in most states.

It is known in the prior art to provide a pharmacy billing computer system which creates labels or cards for attachment to medicine containers. Such information is retained in prescription data files within the systems which are available to provide an interface for more sophisticated treatment of the information. The medicine information used in this prior art is the legally mandated information affiliated with the container, not the entire drug regimen, and thus requires both a tedious reference to the information organized by medicine to validate its sufficiency as defined by the doctor and that this validation be performed manually. The medicine information also does not define the type of container that is to be used in a multi packaging environment.

It is known in the prior art to provide medicine dispensing containers for the patient, oriented by the day and time the medicines are to be taken. The containers are divided up into a number of compartments or packets (which may correspond to the days of the week or times of the day). The pharmacist or patient can then divide up the medication to be taken into the different compartments or packets.

It is known in the prior art to provide automated dispensing equipment and systems that organize the drugs within individual containers of medicines, but such equipment does not provide compliance charts for the pharmacist or patient to validate the accuracy of the medicines so dispensed. The medicine information used in this prior art is the legally mandated information affiliated with the container, not the entire drug regimen and thus requires a tedious reference to the information organized by medicine to validate its sufficiency as defined by the doctor and requires that this validation be performed manually.

It is known in the prior art that different types of medicines cannot fit in all forms of containers. The trays that are popular cannot take medicines dispensed in syringes, and liquid medicines cannot be dispensed in trays either. Therefore it is necessary to identify the type of dose container that a medicine can be used with, and this impacts any validation card that must be generated, creating greater confusion when validating the medicine regimen.

The medicine dispensing containers and medicine information of the type known in the prior art do not solve all of the problems associated with the dispensing of multiple medications. In most States the law requires that all medication be accompanied by a label which includes specified information concerning the medication. This information typically includes the dosage, patient name and dispensing schedule. In the prior art, the labeling information is generated for the individual container in which the medicine is sold oriented by medicine exactly as the physician described it and without visual representations of the medicines. As a result, a dispensing pharmacy must follow a complex, tedious and risk filled process to figure out the specifics of the medications for the pre-packaged individual compartments or packets of the containers. Even when automated systems are used, they provide the information for a single container, rather than the complete regimen, and are oriented to the pharmacist's dispensing problem alone, not to patient and pharmacist validation and do not provide graphical representations to simplify the validation.

In many situations, the patient may suffer side effects from her illness or medications and these frequently include dementia, memory loss or decreased mental capacity. In these situations, it is obvious that only the pharmacist should sort out the medicines, as requiring the patient to divide up her own medication could present serious consequences. However this increases the complexity and time needed to fill a prescription.

Another problem arises in that the patient, typically being a layman without medical training or experience, is not easily able to visually differentiate between different types of pills or capsules. Therefore, if the patient's pills become mixed or spilled, it can be a difficult task for the patient to sort out the medications and be able to resume their dosage regimen.

Another problem exists when medicines are packaged by dose and the information is provided in the legally mandated form of the prior art. The patient has reasonable concerns that the translation was accurately accomplished and the pharmacist has accurately dispensed the medicines into the correct compartments or packets. This concern creates stress for the patient that can only be alleviated by validating what the pharmacist has done. This validation by the patient can be quite tedious if no assistance is provided in reorienting the information about the medicines into dose based information on the patient's behalf and providing duplicated graphical representation to simplify the relationship, in the immediate vicinity of the legally mandated information.

The present invention overcomes the limitations of the prior art by providing a medicine compliance system which provides a patient with an easy and effective method of keeping track of medicines which must be taken. To accomplish creating this validation tool is a complex and time consuming process if created manually. The present invention takes the legally mandated information and creates a second set of arrays or diagrams with an alternative format of the information. The present invention organizes the information and relates the information between the two systems in an easy form for validation, saving time, and reducing the stress of validating the accuracy of the dispensing work performed.

### OBJECTS AND SUMMARY OF THE INVENTION

The present invention provides a medicine compliance system which is intended and designed to overcome the limitations of the prior art. The system is intended to be used in instances where a patient has been prescribed multiple different medications which must be taken on a fixed schedule. With the present invention, a dispensing container includes a number of different compartments or packets. These compartments or packets will correspond to allocated time indications, such as the days of the week and dosage times of the day. A pharmacy billing system provides the prescription information of the entire regimen of medicines.

A medicine compliance system in accordance with the present invention will create a new orientation of this medicine information in the form of an information card. Coupled to the dispensing container, the information card provides a patient with a textual and visual representation of the medicine to be taken at all times and days. The information card also contains an array or diagram of the dose based dispensing container which shows what medicines are to be included in any specific dose compartments or packets and are intended to be taken at a specific day and time. This information shows the pharmacist and patient a written and visual description of the medicine that should be included in that compartment or packet. The two sets of information are provided together to make it easy to relate and validate the translation from one format of data to the other.

The complex translation from one format to another will be accomplished by the medicine compliance system, utilizing a computer, to speed the process and eliminate the otherwise exorbitant time to convert the data from the legally mandated format to the format needed for easy compliance.

Thus, in accordance with one embodiment of the invention, a medical compliance system comprises a computer for converting input medicine information about a plurality of different medicines in a per medicine format into output medicine information in a dosage format, and an output device for generating an information card bearing validation information including at least a first portion of the input medicine information and a second portion of the output medicine information, the first and second portions being related to enable validation of a respective dosage of each of the medicines by inspection of the information card. The system may further comprise a medicine dispensing container for containing the dosages of the medicines, the validation information enabling validation of the dosages contained in the container.

In another embodiment, the present invention is directed to a method for carrying out these functions.

In accordance with a further embodiment, a medical compliance system is provided for validating compliance with an entire drug regimen of dosages of a plurality of different medicines in which the dosages are to be taken at respective allocated times. The system comprises a medical dispensing container having a plurality of compartments for holding medicine, each compartment corresponding to a respective one of the allocated times, and each dosage to be contained in a respective one of the compartments being intended to be taken at the respective allocated time in accordance with the regimen. The system further comprises an information card bearing validation information including input medicine information about the plural different medications in a per medicine format and output medicine information corresponding to the input medicine information in a dosage based format, the input and output medicine information being related to enable validation by inspection of the information card that each dosage of each of the medicines is in a correct one of the compartments.

Generally, each of the allocated times may correspond to one of a plurality of time intervals, such as the days of the week, such that the dosages intended to be taken during a respective one of the time intervals constitute a respective sub-regimen. The system then advantageously comprises a separate information card for at least each time interval corresponding to a different sub-regimen, and preferably comprises a minimum number of information cards such that each time interval is represented by one of the information cards,

For example, if each day's sub-regimen is different, seven cards are generated. As another example, if the weekdays have one sub-regimen and the weekends have a different sub-regimen, two cards are generated. If all the sub-regimens are the same, only one card is generated.

These and other objects, features and advantages of the present invention will be made apparent from the following detailed description of the preferred embodiments taken in conjunction with the attached drawings.

### BRIEF DESCRIPTION OF THE DRAWINGS

The invention will be further described with reference to the drawings in which like elements are represented by the same number.

FIG. 1 is a flow chart of a preferred embodiment of the medicine dispensing system in accordance with the present invention, showing the processes by which the arrays or diagrams are determined and created from the information databases to display the information on the combined information card which aligns with the trays or packages.

FIG. 2 is a flow chart of the algorithm used to calculate the minimum number of arrays or diagrams needed to present the information to the pharmacist or patient in a written form on the combined information card.

FIG. 3 is a detailed view showing sample data for particular medications on a typical information card of the present invention.

FIG. 4 is a view of a set of information cards, showing the complex situation when the minimum number requires that there be a separate card for each day of the week.

FIG. 5 is a perspective view of a preferred embodiment of a dispensing container associated with the medicine dispensing system of the present invention, showing 7 trays with 4 compartments (which by itself is prior art) that correlate to the information card, whereby the information card alone and the information card aligned with the dispensing container are in accordance with the present invention.

FIG. 6 is a perspective view of a preferred embodiment of the dispensing container associated with the medicine dispensing system of the present invention, showing the details of a single tray with 4 compartments that correlate to the information card.

FIG. 7 illustrates an alternative preferred embodiment of the dispensing container associated with the present invention showing the use of 7 packages with 4 packets (which by themselves are prior art) that correlate to the information card, whereby the information card itself and the information card in combination with the packages are in accordance with the present invention.

FIG. 8 illustrates a traditional dispensing container, a vial, which can be used for single medicines or multi medicine cocktails taken “as needed” in relation to a complete medicine regimen.

### DETAILED DESCRIPTION OF THE PREFERRED EMBODIMENTS

A medicine compliance system in accordance with the present invention will be described. In the following description, for the purposes of explanation, specific construction details, arrangements and materials are set forth in order to provide a more thorough understanding of the present invention. It will be apparent to those skilled in the art, however, that the present invention may be practiced without these specific details.

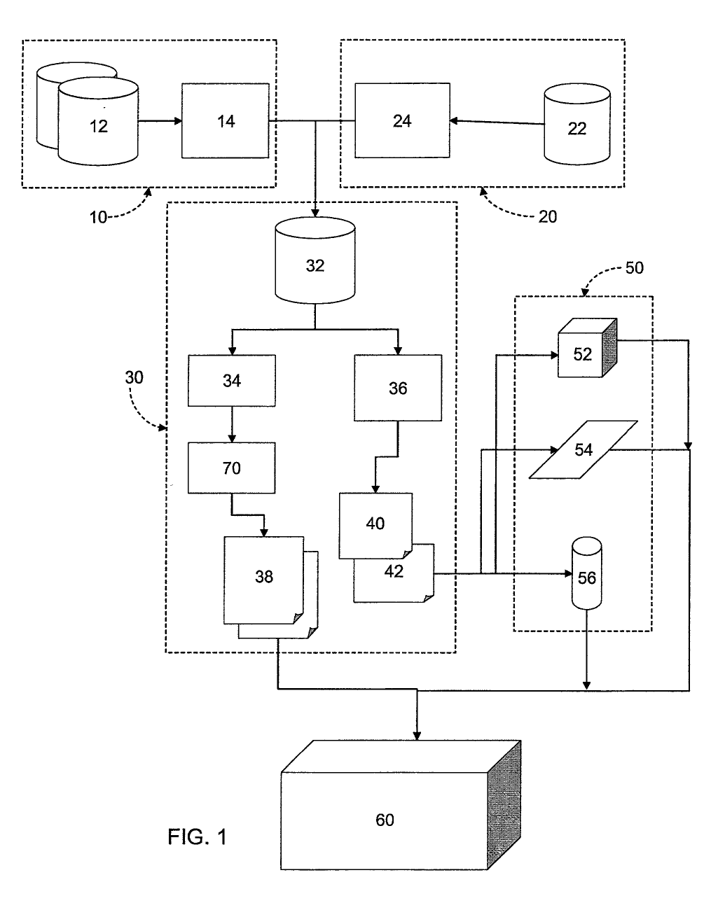

Referring first to FIG. 1, a flow chart of a preferred embodiment of the present invention is shown.

The preferred embodiment of the invention assumes various types of medicine dispensing containers, all of which are prior art, including trays (52), packages (54) and vials (56). Other than their physical differences, trays and packages are logically treated the same, and so trays will be used as the first example.

The preferred embodiment also assumes use of the industry standard visual representation of medicines that are available from various computer services (20) which include software (24) and a database of the medicines (22), but it will be apparent to those skilled in the art that the present invention may be practiced by providing visual representations or icons from alternative sources, or even by creation of a unique set of representations through a custom system.

The flow chart shows an industry typical pharmacy billing system (10) composed of software (14) and a set of databases for pharmacy, medicine, doctor and patient information (12). The prescription information from the billing system is married with the graphical representation of the medicine on the prescription and the type of packaging though the capabilities of the medicine compliance system (32).

The information card is then created providing two formats of the information, a per medicine standard, which will generally be the industry standard (34), and a dosage validation format (36). The industry standard format provided for attachment to vials or simple packaging (40) also includes instructions on how to package in trays or dose packaging (42), oriented by medicine. The second, dosage validation format of information including the total drug regimen is provided by cross reference arrays or diagrams to easily validate that the medicine regimen was correctly packaged (38).

In accordance with an advantageous aspect of the present invention, the number of different information cards is minimized by the optimization algorithm (70) of the medicine compliance system. The complete medicine regimen for the patient with all components of the medicine compliance system is the result (60).

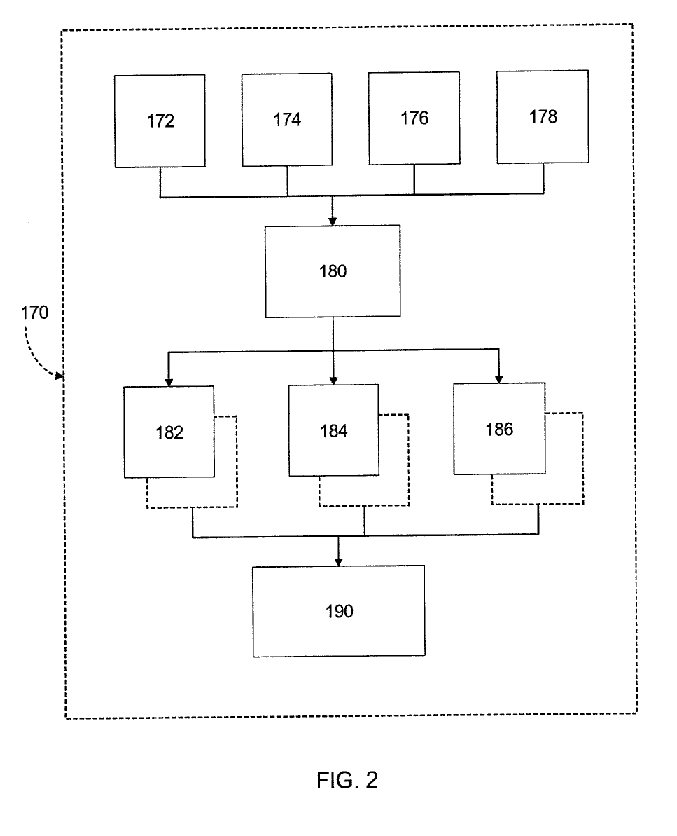

Referring next to FIG. 2, a flow chart of the optimization algorithm and process (170) for minimizing the number of arrays or diagrams and providing details of the process (70) from FIG. 1 is indicated.

The information about the drug regimen is, selected, including the medicine details required by the prescription (172), the visual representation (174), the container requirements for the medicine (176) and the quantity for each dosage time and day (178). This information is then processed (180) to create arrays for each day and each container type: trays (182), packages (184) and vials (186).

It will be apparent to those skilled in the art, however, that the present invention may include more or fewer container types, and may also include new container types for dosage medicines as those container types are invented. For example, blister packs are an additional type of container that could be used.

Before the information is printed out, identical arrays or diagrams for a compartment or packet or vial are consolidated (190) for all days that are the same, and the minimal number of information charts needed are then printed. It is typical that many patients will only have one pattern and one type of container, and thus need only a single information card. More complex regimens with multiple container needs and multiple dosage patterns could have as many as 7 for each type of container required. Those skilled in the art will recognize that the logic sequence can be inverted without altering the spirit of the present invention.

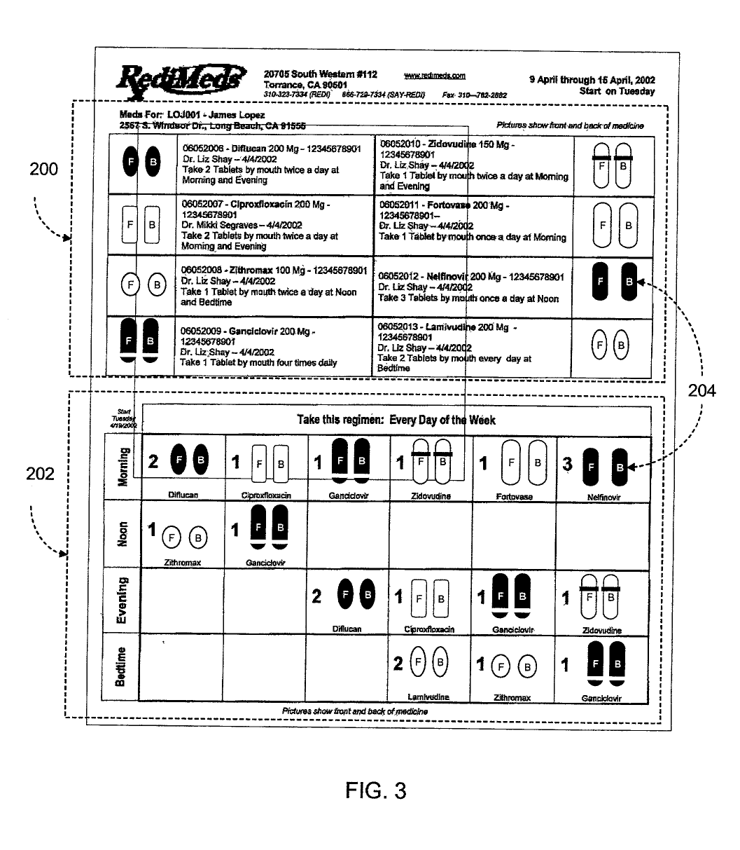

Referring next to FIG. 3, a schematic view of a typical information card is illustrated. The preferred embodiment of the information card includes a written and visual description of the medications in the set of trays or packages oriented “by medicine” (200), i.e. in a per medicine format, and a second written and visual description of the medications in a compartment of the container for each dosage time and day (202), i.e. a dosage validation format. Additional information such as information about the company providing the information card, its address, the time frame of the information card (e.g. an expiration date) and the patient is indicated at the top of the information card for illustrative purposes, but those skilled in the art will recognize this information could be placed in other locations, below and to the side of the arrays and diagrams.

For each different medication, at least three different information fields are provided: a visual representation, the name of the medicine and the quantity. A visual representation of the medication (204) is shown in each information set. This visual representation permits the patient to easily identify each different medication and relate the information. Those skilled in the art will recognize that the placement of the visual representations in the two sets of information can be moved around within the individual sets of information and not change the essence of the relationship function.

An array or diagram (202) is provided which clearly indicates where each type of medication is placed in the tray and the time period when the medication should be taken. The specific day and time period (such as morning, noon, evening, bedtime, and the like) when each dosage is to be taken are listed.

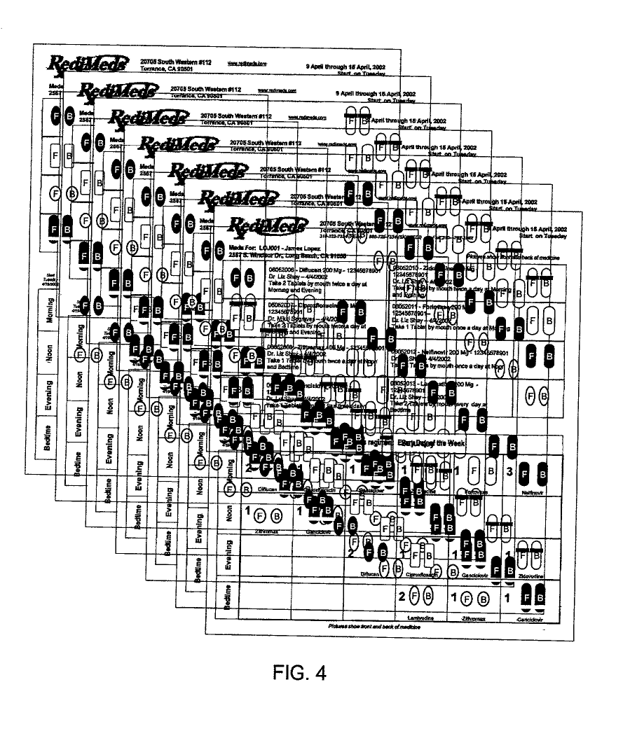

FIG. 4 illustrates the situation where multiple different information cards are provided, one for each day of the week, which would only occur when every single day of the week is different, a rare occurrence. Normally the optimization routine of the medicine compliance system would create fewer consolidated information cards that represented multiple days for a specific type of medicine container.

It will be apparent to those skilled in the art, however, that the present invention can be practiced without some or all of these details. For example, the information card (38) may omit the written description of the medication, and provide only a visual representation of the medicine. In other instances, it may be desirable to provide only a written description of the medication with an icon for the relationship.

In an alternative embodiment of the invention, the data on the information card is provided entirely in Braille, so that blind patients may also make use of the present invention.

Additional data fields may also be added to the data card. For example, information concerning drug interactions, allergies specific to the patient or other information such as “take with food” can be included.

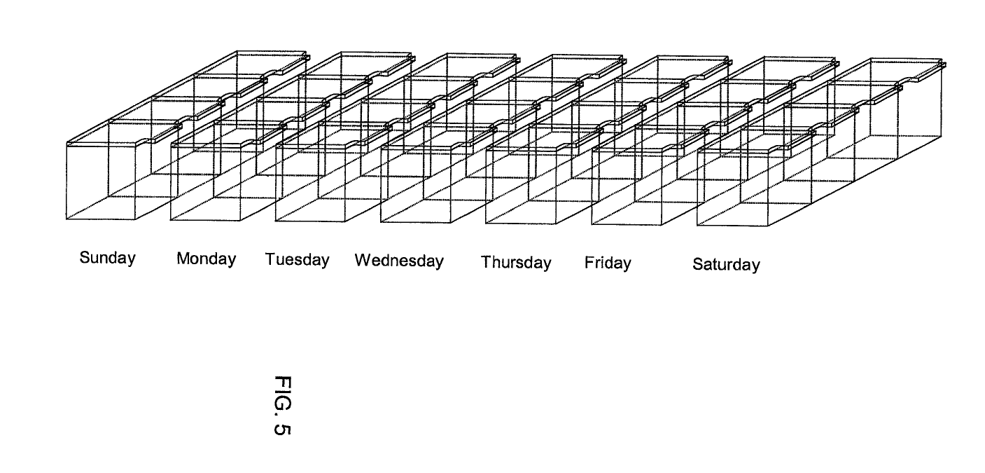

In FIG. 5 a group of medicine trays is provided to indicate the typical medicine dispensing container for pills. In the preferred embodiment, the tray is manufactured from an inert material such as plastic, which will not react with the medicine to be taken. The exact number of trays or packages in a set can vary, though the preferred embodiment would be, as indicated, seven, one for each day of the week. It will be apparent to those skilled in the art however, the set may include a smaller or larger number of containers (e.g. fourteen, corresponding to a two-week schedule for taking medication, etc.) and even multiple types of containers.

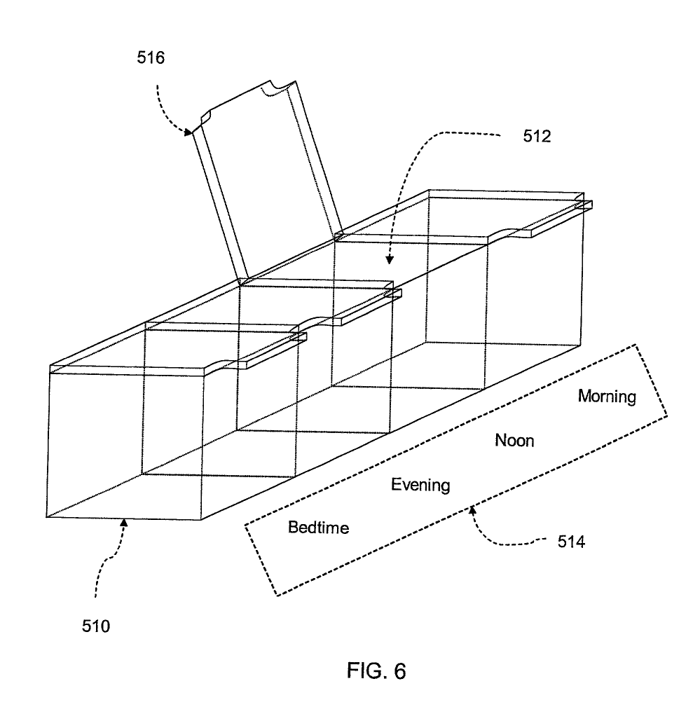

In FIG. 6 a tray (510) has been shown with a typical plurality of compartments, including one that is open (512). The compartments are of such a size that they can accommodate a number of different medications in the form of pills or capsules (not shown in FIG. 6). Each compartment includes a lid (516) which may be snapped closed in order to keep the medication in the compartments without spilling.

The exact number of compartments in the tray can vary. In the preferred embodiment, there are four compartments formed into the tray, each corresponding to a time of the day and equating to the industry standard four dosage times of morning, noon, evening and bedtime (514).

If desired, the lids of each compartment may be printed with the day of the week and dosage time (Sunday Morning, Monday Noon, Tuesday Evening, etc.). It will be apparent to those skilled in the art, however, that the tray may include a smaller or larger number of compartments without departing from the overall spirit and scope of the present invention. For example, the tray (510) may have three compartments or five compartments, and the number would be tied to the appropriate arrangement in the arrays or diagram of the information card.

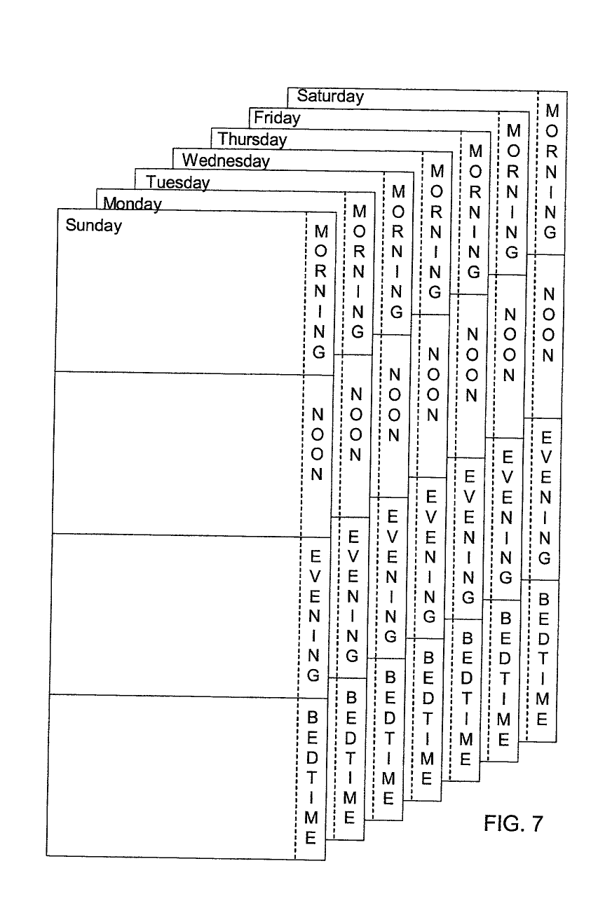

An alternative for the dispensing container of the medicines is indicated in FIG. 7, where the medicines will be inserted into a package instead of a tray, and where each package has a number of packets for each dosage of medicines, equivalent to the compartments of a tray. This configuration for the dispensing container is advantageous for non-pill medicines such as syringes or individual doses of liquid medicines.

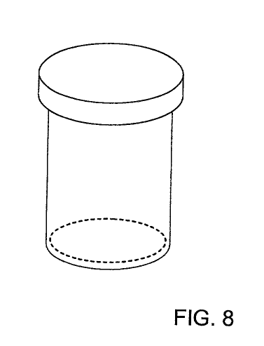

Another alternative for the dispensing container of the medicines is indicated in FIG. 8, where the medicine or medicines will be inserted into a vial instead of a tray and will be used whenever the regimen includes specific medicines or “cocktails” to be taken not on a dosage schedule but “as needed.”

The above description of the present invention has been made with respect to system generation of an information card for use in validating a medicine dispensing container or containers. It will be apparent to those skilled in the art that the foregoing description is for illustrative purposes only, and that various changes and modifications can be made to the present invention without departing from the overall spirit and scope of the present invention. Thus, while the present invention has been described with reference to the foregoing embodiments, changes and variations may be made therein which fall within the scope of the appended claims, and the full extent of the present invention is defined and limited only by the claims.

1. A medical compliance system, comprising:
a computer for converting input medicine information about a plurality of different medicines in a per medicine format into output medicine information in a dosage format; and
an output device for generating an information card bearing validation information including at least a first portion of the input medicine information and a second portion of the output medicine information, the first and second portions being related to enable validation of a respective dosage of each of the medicines by inspection of said information card.

2. The system of claim 1, further comprising a medicine dispensing container for containing the dosages of the medicines, the validation information enabling validation of the dosages contained in said container.

3. The system of claim 2, where in the plurality of medicines constitute an entire drug regimen in which the dosages are to be taken at respective allocated times, wherein said container has a plurality of compartments for holding medicine and each said compartment corresponds to a respective one of the allocated times, and wherein each dosage to be contained in a respective one of said compartments is intended to be taken at the respective allocated time in accordance with the regimen, said validation information enabling validation that each dosage is in a correct one of said compartments.

4. The system of claim 3, wherein said second portion of said output medicine information includes at least one of a name of each medicine, a respective quantity of medicine to be taken as each dosage and a visual representation of the medicine to be taken as each dosage.

5. The system of claim 4, wherein said first portion of said input medicine information includes at least one of the name of each medicine, the respective quantity of medicine to be taken as each dosage and the visual representation of the medicine to be taken as each dosage.

6. The system of claim 1, wherein said second portion of said output medicine information includes at least one of a name of each medicine, a respective quantity of medicine to be taken as each dosage and a visual representation of the medicine to be taken as each dosage.

7. The system of claim 6, wherein said first portion of said input medicine information includes at least one of the name of each medicine, the respective quantity of medicine to be taken as each dosage and the visual representation of the medicine to be taken as each dosage.

8. The system of claim 1, wherein the plurality of medicines constitute an entire drug regimen in which the dosages are to be taken at respective allocated times, each of the allocated times corresponding to one of a plurality of time intervals such that the dosages intended to be taken during a respective one of the time intervals constitute a respective sub-regimen, and wherein said output device generates a separate information card for at least each time interval corresponding to a different sub-regimen.

9. The system of claim 8, wherein said computer determines a minimum number of information cards required to represent each different one of the sub-regimens, and wherein said output device generates the minimum number of information cards such that each time interval is represented by one of the information cards.

10. The system of claim 9, wherein each time interval is a respective day of the week.

11. The system of claim 8, wherein said output device generates an information card for each time interval.

12. A method of validating medical compliance of dosages of a plurality of different medicines, comprising the steps of:
using a computer to convert input medicine information about the plurality of different medicines in a per medicine format into output medicine information in a dosage format; and
generating an information card bearing validation information including at least a first portion of the input medicine information and a second portion of the output medicine information, the first and second portions being related to enable validation of a respective dosage of each of the medications by inspection of the information card.

13. The method of claim 12, further comprising the step of providing a medicine dispensing container for containing the dosages of the medicines, wherein the plurality of medicines constitute an entire drug regimen in which the dosages are to be taken at respective allocated times, wherein the container has a plurality of compartments for holding medicine and each compartment corresponds to a respective one of the allocated times, and wherein each dosage to be contained in a respective one of the compartments is intended to be taken at the respective allocated time in accordance with the regimen, the validation information enabling validation that each dosage is in a correct one of the compartments.

14. The method of claim 13, wherein the plurality of medicines constitute an entire drug regimen in which the dosages are to be taken at respective allocated times, each of the allocated times corresponding to one of a plurality of time intervals such that the dosages intended to be taken during a respective one of the time intervals constitute a respective sub-regimen, and wherein said generating step generates a separate information card for at least each time interval corresponding to a different sub-regimen.

15. The method of claim 14, wherein said using step determines a minimum number of information cards required to represent each different one of the sub-regimens, and wherein said generating step generates the minimum number of information cards such that each time interval is represented by one of the information cards.

16. The method of claim 12, wherein the input medicine information includes information derived from at least one of a database of the medicines, a database of visual representations of the medicines and a pharmacy billing set of databases for pharmacy, medicine, doctor and patient information. respective allocated time in accordance with the regimen, the validation information enabling validation that each dosage is in a correct one of the compartments.

14. The method of claim 13, wherein the plurality of medicines constitute an entire drug regimen in which the dosages are to be taken at respective allocated times, each of the allocated times corresponding to one of a plurality of time intervals such that the dosages intended to be taken during a respective one of the time intervals constitute a respective sub-regimen, and wherein said generating step generates a separate information card for at least each time interval corresponding to a different sub-regimen.

15. The method of claim 14, wherein said using step determines a minimum number of information cards required to represent each different one of the sub-regimens, and wherein said generating step generates the minimum number of information cards such that each time interval is represented by one of the information cards.

16. The method of claim 12, wherein the input medicine information includes information derived from at least one of a database of the medicines, a database of visual representations of the medicines and a pharmacy billing set of databases for pharmacy, medicine, doctor and patient information.

17. A medical compliance system for validating compliance with an entire drug regimen of dosages of a plurality of different medicines in which the dosages are to be taken at respective allocated times, said system comprising:
a medical dispensing container having a plurality of compartments for holding medicine, each said compartment corresponding to a respective one of the allocated times, and each dosage to be contained in a respective one of said compartments being intended to be taken at the respective allocated time in accordance with the regimen; and
an information card bearing validation information including input medicine information about the plural different medications in a per medicine format and output medicine information corresponding to the input medicine information in a dosage based format, the input and output medicine information being related to enable validation by inspection of said information card that each dosage of each of the medicines is in a correct one of said compartments.

18. The system of claim 17, wherein each of the allocated times corresponds to one of a plurality of time intervals such that the dosages intended to be taken during a respective one of the time intervals constitute a respective sub-regimen, said system comprising a separate information card for at least each time interval corresponding to a different sub-regimen.

19. The system of claim 18, wherein said system comprises a minimum number of information cards such that each time interval is represented by one of said information cards.

20. The system of claim 12, wherein the output medicine information includes at least one of a name of each medicine, a respective quantity of medicine to be taken as each dosage and a visual representation of the medicine to be taken as each dosage, and the input medicine information includes at least one of the name of each medicine, the respective quantity of medicine to be taken as each dosage and the visual representation of the medicine to be taken as each dosage.
